(19) United States
(12) Patent Application Publication
(10) Pub. No.: US 2012/0035341 A1
(43) Pub. Date: Feb. 9, 2012

(54) PROCEDE DE POLYMERISATION PAR VOIE CATALYTIQUE DE 1,4-DIOXANES-2,5-DIONES ET LES POLYMERES CORRESPONDANTS

(75) Inventors: Jean-Pierre Diehl, Lille (FR); Olivier Thillaye Du Boullay, Montans (FR); Didier Bourissou, Plaisance Du Touch (FR); Blanca Martin-Vaca, Toulouse (FR)

(73) Assignees: MINASOLVE, Beuvry-la-foret (FR); CENTRE NATIONAL DE LA RECHERCHE SCIENTIFIQUE (CNRS), Paris (FR); UNIVERSITE PAUL SABATIER TOULOUSE III, Toulouse (FR)

(21) Appl. No.: 13/254,870

(22) PCT Filed: Mar. 8, 2010
(86) PCT No.: PCT/FR10/50394

§ 371 Date: Oct. 26, 2011

(30) Foreign Application Priority Data
Mar. 6, 2009 (FR) 0901051

(51) Int. Cl. C08G 2/20; C08G 2/06; C08G 2/00

(52) U.S. Cl. 528/223; 528/220; 528/224; 528/222; 528/226; 528/229

(57) ABSTRACT

A method for polymerizing 1,4-dioxane-2,5-diones in the presence of a generally protic initiator and at least one catalyst including at least one metal-free organic compound. The latter is a non-metal organic catalyst most often selected from among pyridines of which DMAP is a derivative, sulfonic acids, polycyclic tertiary amines, phosphazenes, thioureas, thioureas/amines, and guanidines. The invention also relates to polymers obtained by the method.

The invention relates to 1,4-dioxane-2,5-diones, their synthesis and their catalytic polymerization. These 1,4-dioxane-2,5-diones are preferably functionalized and dissymmetrical, i.e. they comprise functionalized groups, generally positioned symmetrically with respect to the 6-atom ring of the dioxane-dione, and distinct from each other.

According to the invention, the 1,4-dioxane-2,5-diones preferably comprise two functional groups distinct from each other and positioned symmetrically with respect to the 6-atom ring of the 1,4-dioxane-2,5-dione, one preferably being the hydrogen atom and the other preferably being a functional group introduced by an α-hydroxyacid derived from amino acid.

There is growing interest in polyglycolides (or PGAs for “poly(glycolic acid”)) as well as their copolymers with lactic acid, the polyglycolide-co-lactides (PLGAs).

Glycolide or 1,4-dioxane-2,5-dione is the diester forming a 6-atom ring constituted by two glycolic acid units. A polyglycolide is a glycolic acid polymer formed, most often, by ring opening polymerization (or ROP) of glycolide.

Lactide or 3,6-dimethyl-1,4-dioxane-2,5-dione is the diester forming a 6-atom ring constituted by two lactic acid units. A polylactide (or PLA for “poly(lactic acid)”) is a lactic acid polymer generally obtained by ring opening polymerization of lactide.

Modification of the properties of PGAs, PLAs and PLGAs, mainly in terms of biodegradability and biocompatibility, constitutes a significant challenge, in particular for extending their uses in the medical and cosmetic fields.

One approach aimed at better adjusting their properties, consists of incorporating functionalized groups along the polymer chain. To this end, dissymmetrical 1,4-dioxane-2,5-diones, substituted in position 3 and/or 6, are synthesized.

These chains can significantly modify the properties of said polymers and make it possible, for example, to establish favoured interactions with an active ingredient.

The preparation of PGAs, PLAs and PLGAs by ring opening of the glycolide and lactide cyclic diesters is carried out by ring opening of the monomers (cyclic diesters) then polymerization. This polymerization is carried out using at least one initiator.

By “initiator” is meant according to the invention a chemical agent which participates in starting the polymerization reaction.

The polymerization of these functionalized 1,4-dioxane-2,5-diones has been studied exclusively using metal catalysts such as stannous octoate (tin (II)-2-ethylhexanoate: Sn (C₇F₁₅COO₂)).

Nevertheless, the low reactivity of the monomers as well as the catalytic systems generally used, requires a high reaction temperature, for example comprised within a range from 120° C. to 180° C. Such a temperature makes it difficult, or even impossible, to control the polymerization and therefore to control the properties of the polymer.

Thus, none of these methods is truly satisfactory.

Furthermore, the polymers obtained contain numerous metal impurities, due to the presence of metal in the catalysts. In fact, the use of a catalyst based on a tin complex generally involves from 0.01 to 0.2% by mass of tin metal relative to the monomer unit of the polymer; the use of a catalyst based on an aluminium complex generally involves at least 0.1% by mass of aluminium relative to the monomer unit of the polymer; the use of a catalyst based on a zinc complex involves at least 0.2% by mass of zinc relative to the monomer unit of the polymer.

These metal impurities make the polymers obtained unusable without subsequent purification treatment, and constitute a significant limitation depending on the envisaged field of use, in particular with regard to the medical field and the cosmetic field.

Moreover, the presence of the functionalized side chains at present makes the purification of these polymers very difficult or even impossible.

The Applicant therefore proposes a polymerization method for 1,4-dioxane-2,5-diones in the presence of at least one generally protic initiator and at least one catalyst, said method being characterized in that the catalyst comprises at least one organic compound devoid of metal.

The catalyst according to the invention is generally chosen from:
the pyridines, and in particular the 4-amino-pyridines, substituted or not, in particular in position 2 and/or 3 by at least one C₁-C₁₂ alkyl group; substituted or not, in particular in position N′ by at least one C₁-C₁₂ alkyl group such as N′,N′-dimethylamino-4-pyridine (also known as DMAP); in the case of substitution by at least two groups, these groups can be fused together;
the sulphonic acids of formula R′SO₃H, where R′ is an aryl or alkyl group, such as paratoluenesulphonic acid, methanesulphonic acid and trifluoromethanesulphonic acid (abbreviated to PTSA, MSA and TfOH respectively);
the polycyclic tertiary amines such as 1,8-diazabicyclo[5.4.0]undec-7-ene (DBU) or 1,5-diazabicyclo[4.3.0]non-5-ene (DBN);
the cyclic or acyclic guanidines, such as 1,5,7-triazabicyclo-[4.4.0]dec-5-ene (also known as TBD);
the mono- or poly-phosphazenes such as 2-tert-butylimino-2-diethylamino-1,3-dimethylperhydro-1,3,2-diazaphosphorine (also known as BEMP);
the combinations:
   of at least one thiourea of general formula R₁NH—C(═S)—NHR₂ in which the R₁ and R₂ groups, distinct or not, are aryl or alkyl groups, optionally substituted, generally chosen from the group formed by the C₁-C₁₂ alkyl groups, linear or branched, the C₃-C₇ cycloalkyl groups and the C₆-C₁₂ aromatic groups, fused or not, each of said groups being able to be substituted or not by a halogen, CF₃, NO₂, NHCOCH₃, or a C₁-C₁₂ alkyl group, linear or branched, and
   of at least one tertiary amine, aliphatic or aromatic, mono or polyamine,
with a thiourea/tertiary amine ratio varying preferably from 0.1 to 10, such as in particular the combination of the thiourea known as thiourea 1, of formula,

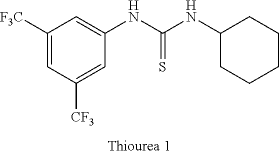

and sparteine.
the thioureas of general formula R₃NH—C(═S)—NHR₄ in which the R₃ and R₄ groups, distinct or not, are aryl or alkyl groups, optionally substituted, comprising at least one tertiary amine function, generally chosen from the group formed by the C₁-C₁₂ alkyl groups comprising at least one tertiary amine function, linear or branched, the C₃-C₇ cycloalkyl groups comprising at least one tertiary amine function, the C₆-C₁₂ aromatic groups, fused or not, comprising at least one tertiary amine function and the C₃-C₁₂ heterocycloalkyl groups, fused or not, comprising at least one tertiary amine function, each of said groups being able to be substituted or not by a halogen, CF₃, NO₂, NHCOCH₃, a C₁-C₁₂ alkyl group, linear or branched, such as the thiourea known as thiourea 2, of formula:

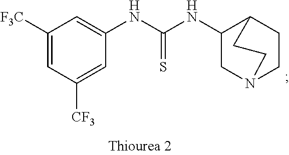

the combinations:
   of at least one thiourea of general formula R₅NH—C(═S)—NHR₆ in which the R₅ and R₆ groups, distinct or not, are aryl or alkyl groups, optionally substituted, comprising at least one tertiary amine function, generally chosen from the group formed by the C₁-C₁₂ alkyl groups comprising at least one tertiary amine function, linear or branched, the C₃-C₇ cycloalkyl groups comprising at least one tertiary amine function, the C₆-C₁₂ aromatic groups, fused or not, comprising at least one tertiary amine function and the C₃-C₁₂ heterocycloalkyl groups, fused or not, comprising at least one tertiary amine function, each of said groups being able to be substituted or not by a halogen, CF₃, NO₂, NHCOCH₃, a C₁-C₁₂ alkyl group, linear or branched, such as the thiourea known as thiourea 2, and
   of at least one tertiary amine, aliphatic or aromatic, mono or polyamine,
such as the combination of thiourea known as thiourea 3, of formula

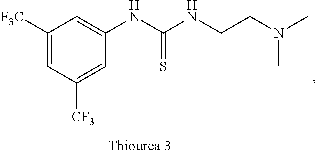

and sparteine.

By “combination” of compounds, is meant according to the invention the concomitant presence of at least two compounds thus constituting a catalytic system where each compound of the combination can play a specific role such as the activation of a monomer or the activation of the initiator.

The names thiourea 1, thiourea 2 and thiourea 3 are specific to the text, and are meant to simplify the writing of these thiourea compounds. Thiourea 1 is 1-(3,5-bis-trifluoromethyl-phenyl)-3-cyclohexylthiourea. Thiourea 2 is 1-(1-Aza-bicyclo[2.2.2]oct-3-yl)-3-(3,5-bis-trifluoromethyl-phenyl)-thiourea, and thiourea 3 is 1-(3,5-bis-trifluoromethyl-phenyl)-3-(N′,N′ dimethylaminoethyl)-thiourea.

Thus, preferably, the organic catalyst is a thiourea comprising a tertiary amine (such as thiourea 2), or a combination of at least one thiourea (such as thiourea 1) and at least one tertiary amine (such as sparteine), or a combination of at least one thiourea comprising a tertiary amine (such as thiourea 3) and at least one tertiary amine (such as sparteine).

In a particularly useful manner, the method according to the invention makes it possible to obtain a polymer devoid of metal impurities, which advantageously allows its use in fields such as pharmaceuticals, surgery or also cosmetics. Furthermore, such a polymer most often has a particularly useful ratio of weight average molecular weight (Mw) to number average molecular weight (Mn), i.e. slightly greater than 1 and most often less than 1.40, preferably less than 1.38, even more preferably less than 1.35. This ratio is also called the polydispersion index (PDI=Mw/Mn) or polymolecularity index.

The method according to the invention is advantageously implemented under mild operating conditions, generally at a temperature comprised within a range from −80° C. to 100° C. and preferably from 0° C. to 40° C.

Preferably the 1,4-dioxane-2,5-diones according to the invention are functionalized and dissymmetrical.

Moreover, the dissymmetrical functionalized 1,4-dioxane-2,5-diones according to the invention are generally in the form of pure enantiomers or mixtures of enantiomers. The latter can be more particularly the racemic mixtures.

The polymerization method according to the invention is carried out by ring opening of the 1,4-dioxane-2,5-dione cyclic diesters using at least one generally protic initiator.

By “protic initiator” is meant according to the invention an initiator which can release a proton.

The protic initiator according to the invention is generally a protic reagent such as water, an alcohol, a thiol, a primary amine, or more generally any compound containing an alcohol, thiol or amine function. This is why the protic initiator according to the invention can be expressed by a formula RXH, where R is a group which is specified in the remainder of the text, and XH (for —X—H) an alcohol, amine, thiol function, capable of releasing a proton (H⁺).

The protic initiator can be in particular n-pentyl alcohol or n-pentanol.

The dissymmetrical functionalized 1,4-dioxane-2,5-diones according to the present invention are generally diesters preferably combining lactic acid or glycolic acid with an α-hydroxyacid derived from amino acid, combining even more preferably glycolic acid with an α-hydroxyacid derived from amino acid.

In even more particularly preferred manner according to the invention, the diesters preferably combine glycolic acid and one of the α-hydroxyacids derived from the following amino acids: aspartic acid, serine, threonine, cysteine, lysine and glutamic acid. These derivatives of amino acids lead to a particularly advantageous functionalization of the 1,4-dioxanes-2,5-diones.

In fact, the side functions (i.e. the carboxylic acid, alcohol, thiol or also amine functions) can be exploited in order to establish interactions of an ionic or covalent nature with active ingredients quite particularly in the medical, pharmaceutical, cosmetic and surface-treatment fields.

These preferred combinations between glycolic acid and aspartic acid, serine, threonine, cysteine, lysine and glutamic acid produce the following compounds of formulae (I) to (VI) respectively, from which the 1,4-dioxane-2,5-diones according to the invention are preferentially chosen, in the form of pure enantiomers or a mixture of enantiomers:

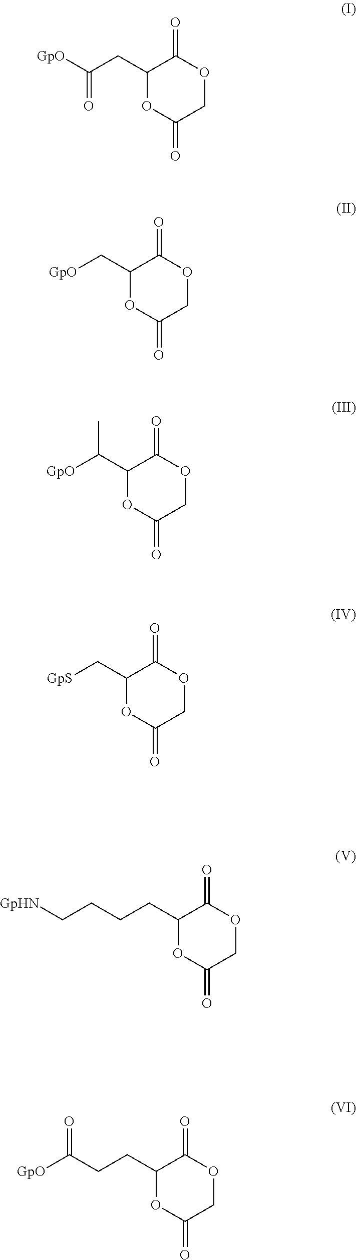

where the Gp group is a protective group or hydrogen H.

In the case where Gp=H, the compounds (I), (II), (III), (IV), (V) and (VI) are respectively:
3-carboxymethyl-1,4-dioxane-2,5-dione,
3-hydroxymethyl-1,4-dioxane-2,5-dione,
3-(1-hydroxy)ethyl-1,4-dioxane-2,5-dione,
3-mercaptomethyl-1,4-dioxane-2,5-dione,
3-(4-amino)butyl-1,4-dioxane-2,5-dione, and
3-carboxyethyl-1,4-dioxane-2,5-dione.

The term “protective group” according to the invention, refers to any group making it possible to temporarily protect the side function of the monomer and of the polymer, and capable of then being removed by chemical conversion in order to release the chemical function of interest. A person skilled in the art is capable of determining the protective groups which can generally be used according to the invention.

In the case where the Gp group is different from hydrogen, Gp is a protective group. In the case where Gp is H, these 1,4-dioxane-2,5-diones are considered to be unprotected or deprotected.

Preferably, the Gp group is chosen from benzyl (also abbreviated to Bz), benzyloxycarbonyl and 4-methylbenzyl. Benzyl is a protective group particularly preferred for the compounds of formula (I), (II), (III), (IV) and (VI) according to the invention. Benzyloxycarbonyl is a protective group also particularly preferred for the compound of formula (V) according to the invention.

In the case where the Gp group is benzyl, the compounds of formula (I), (II), (III), (IV) and (VI) are respectively:
3-(benzyloxycarbonyl)methyl-1,4-dioxane-2,5-dione,
3-benzyloxymethyl-1,4-dioxane-2,5-dione,
3-(1-benzyloxyethyl)-1,4-dioxane-2,5-dione,
3-(benzylmercapto) methyl-1,4-dioxane-2,5-dione, and
3-(2-benzyloxycarbonyl)ethyl 1,4-dioxane-2,5-dione.

In the case where the Gp group is benzyloxycarbonyl, the compound of formula (V) is: 3-(4-benzyloxycarbonylamino)butyl-1,4-dioxane-2,5-dione.

Thus, preferably, the method according to the invention is such that the Gp group is benzyl for the compounds of formula (I), (II), (III), (IV) and (VI) and such that the Gp group is benzyloxycarbonyl for the compound of formula (V).

The compounds of formulae (I) to (VI) can be considered both in the form of enantiomers or mixtures of enantiomers. The mixture of enantiomers is for example the racemic mixture.

The compounds of formula (I) to (VI) are preferably:
3(S)-(benzyloxycarbonyl)methyl-1,4-dioxane-2,5-dione,
3(S)-benzyloxymethyl-1,4-dioxane-2,5-dione,
3(S)-(1-benzyloxyethyl)-1,4-dioxane-2,5-dione,
3(S)-(benzylmercapto) methyl-1,4-dioxane-2,5-dione,
3(S)-(4-benzyloxycarbonylamino)butyl-1,4-dioxane-2,5-dione, and
3(S)-(2-benzyloxycarbonyl)ethyl 1,4-dioxane-2,5-dione.

The starting amino acid which makes it possible to synthesize the compounds of formula (I) to (VI) above has a stereochemistry which is generally retained in the compound synthesized from said amino acid. It is the stereochemistry of the starting amino acid that is found again in the synthesized dioxane-dione. Thus, if the amino acid is in the form of a pure enantiomer, the compound is in the form of a pure enantiomer of the same purity. If the amino acid is in the racemic form, the compound is in the racemic form.

In the remainder of the description, the above compounds (I) to (VI) are considered according to the invention as monomers, i.e. as starting products for the polymerization method. In the polymer chain obtained by the polymerization, the term monomer unit will rather be used to denote the repeat unit within the chain. According to the invention, this monomer unit is distinct from the starting monomer.

In fact, the method according to the invention comprises the implementation of a ring opening polymerization: the ring of the starting monomer is opened in order to produce the monomer unit which is polymerized into a chain.

According to a preferred aspect, the method of the invention produces a polymer obtained from the same dissymmetrical functionalized 1,4-dioxane-2,5-dione. This is then a homopolymer. Thus, the method according to the invention can be characterized in that a homopolymer is obtained.

The invention also relates to a polymer obtained by the implementation of the method as described previously, characterized in that said polymer is a homopolymer.

By “homopolymer”, is generally meant according to the invention a polymer comprising the repetition of a monomer unit. Nevertheless, it is considered that the presence of less than 5% in moles, preferably of less than 3% in moles, of another monomer unit is included within the scope of the definition of a homopolymer according to the invention.

According to another aspect, the invention relates to a method in which two monomers distinct from each other are copolymerized:
at least one of said monomers being chosen from the compounds of formulae (I) to (VI) in the form of a pure enantiomer or of a mixture of enantiomers, and
at least the other of said monomers being chosen from the compounds of formulae (I) to (VI) in the form of a pure enantiomer or of a mixture of enantiomers, and glycolide, optionally substituted.

The glycolide can be substituted by:
a methyl in order to produce for example 3-methyl glycolide,
two methyls in order to produce for example 3,6-dimethyl glycolide or lactide,
a phenyl in order to produce in particular 3-phenyl glycolide,
two phenyls in order to produce in particular mandelide,
two benzyls in order to produce in particular 3,6-dibenzyl glycolide, or
two vinyls in order to produce for example 3,6-divinyl-[1.4]dioxane-2,5-dione.

The invention also relates to a polymer obtained by the implementation of the method according to the invention as described previously, characterized in that said polymer is a copolymer.

By “copolymer”, is generally meant according to the invention the repetition of at least two monomer units distinct from each other. In general, the term “copolymer” is used according to the invention when each of the two monomer units is present in the polymer at a level of at least 3%, preferably at least 5% in moles.

In another aspect, the invention relates to the polymer of a formula chosen from:

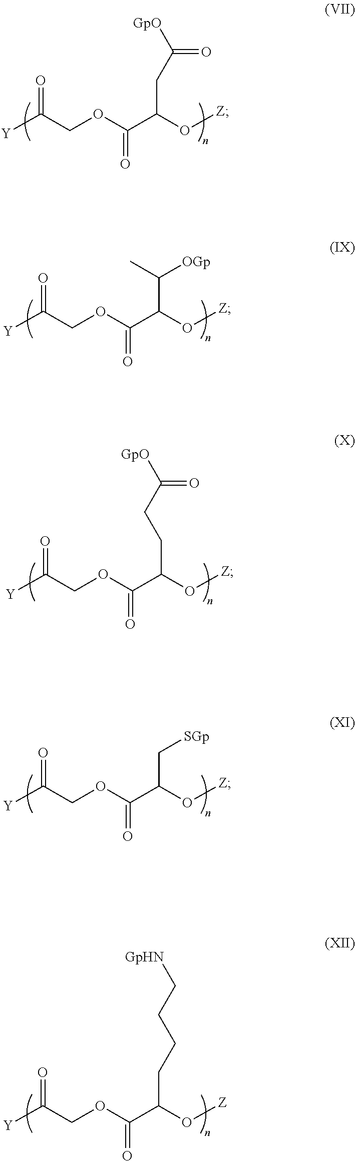

where the Gp group is a protective group as defined previously, or is hydrogen H, and where Y and Z, identical or different, are two terminal groups.

Y and Z are terminal groups known to a person skilled in the art. Preferably Y and Z are respectively equal to RX (for R—X) and H when the polymerization has been obtained with a protic initiator of formula RXH, where X is generally O, NH or S, and where the R group is generally a hydrogen atom, a C₁-C₁₂ alkyl group, linear or branched, a C₃-C₇ cycloalkyl group, a C₆-C₂₄ aromatic group, fused or not, a C₃-C₁₂ heterocycloalkyl group, fused or not, each of said groups being able to be substituted or not by a halogen, an OH protected or not, an NH₂, protected or not, an SH, protected or not, a C₁-C₁₂ alkyl group, linear or branched, or a C₆-C₁₂ aromatic group.

But Y and Z can also be different from RX and H respectively, as known to a person skilled in the art.

Moreover, n is the degree of polymerization, which generally varies from 5 to 500, preferably from 10 to 200.

Said polymer is characterized in that it has a polydispersion index of less than 1.40, preferably less than 1.38, even more preferably less than 1.35.

The weight average molecular weight (Mw), the number average molecular weight (Mn) as well as the polydispersion index, are generally determined directly by steric exclusion chromatography (SEC) also called gel permeation chromatography (GPC), after calibration by standard polystyrene samples as known to a person skilled in the art. This makes it possible to obtain substantially reproducible measurements, irrespective of the system of measurement used, there being little difference between the different systems.

The theoretical Mw/Mn ratio is 1 in the case where the polymer chains are all of similar length. In all cases this ratio is greater than or equal to 1. Advantageously the polymers according to the invention are such that their Mw/Mn ratio is generally less than 1.40, preferably less than 1.38, even more preferably less than 1.35. The measurement of this ratio is generally accurate to ±0.02.

The invention also relates to the polymer comprising the repetition of two monomer units distinct from each other:
at least one of said monomer units being chosen from the monomer units of formulae:

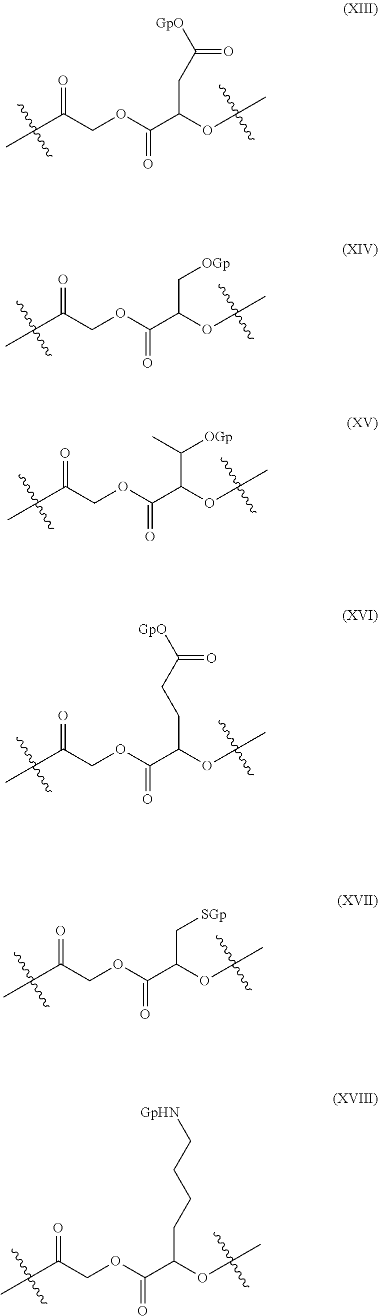

where the Gp group is a protective group as defined previously, or is hydrogen H,
and at least the other of said monomer units being chosen from the compounds of formulae (XIII), (XIV), (XV), (XVI), (XVII) and (XVIII) as described above, and the optionally substituted glycolide,
to the exclusion of a polymer comprising the repetition of the monomer unit (XIV) and of the lactide or 3,6-dimethyl glycolide,
   said polymer being characterized in that it has a ratio of the weight average molecular weight (Mw) to the number average molecular weight (Mn) less than 1.40, preferably less than 1.38, even more preferably less than 1.35.

Such a polymer has two terminal groups, Y and Z as defined previously, usual for a person skilled in the art.

The invention also relates to a polymerization method according to the invention characterized in that said 1,4-dioxane-2,5-dione is 3-(2-benzyloxycarbonyl)ethyl 1,4-dioxane-2,5-dione, preferably 3(S)-(2-benzyloxycarbonyl)ethyl 1,4-dioxane-2,5-dione, and the organic catalyst is a 4-aminopyridine, preferably DMAP.

The invention also relates to a polymerization method according to the invention characterized in that said 1,4-dioxane-2,5-dione is 3-(2-benzyloxycarbonyl)ethyl 1,4-dioxane-2,5-dione, preferably 3(S)-(2-benzyloxycarbonyl)ethyl 1,4-dioxane-2,5-dione, and the organic catalyst is a thiourea comprising a tertiary amine, or a combination of at least one thiourea, optionally comprising a tertiary amine, and at least one tertiary amine.

The following examples are presented in order to illustrate the invention described above and should in no event be considered as a limitation to the scope of the invention.

### EXAMPLES

Raw Materials

n-Pentanol was distilled over sodium. Dichloromethane (DCM) was distilled over P₂O₅. DMAP (Aldrich) was recrystallized three times from toluene. Thioureas 1 and 2 were prepared according to the article Macromolecules 2006, 39, 7863-7871. Thiourea 3 was prepared according to the article Tetrahedron Letters 2004, 1301-1306. Thioureas 1, 2 and 3 were recrystallized twice from chloroform. The (−)sparteine (Aldrich) was distilled over CaH₂.

Characterization

The number average weights (Mn), the weight average weights (Mw) and the polydispersion indices (PDI=Mw/Mn) are determined by steric exclusion chromatography (SEC) with a Styragel HR4E pre-column/column assembly, a Waters system comprising a model 600 pump, a 2410 refraction index detector and a 717 autosampler. Tetrahydrofuran (THF) was used as elution solvent, at 40° C. and with a flow rate of 1 mL/min.

The NMR spectra were recorded with a BRUKER Avance 300 spectrometer at ambient temperature. The chemical shifts were reported in ppm (TMS as external standard).

### I. Examples of the Synthesis of Monomers (III), (IV), (V) and (VI)

All these monomers were prepared on the basis of the synthesis of 3(S)-(benzyloxycarbonyl)methyl-1,4-dioxane-2,5-dione (i.e. monomer (VI) when the Gp group is benzyl) of the example on pages 255 to 265 of Patent Application WO 2005/121904.

### Example I 1

### Synthesis of Monomer (VI) when the Gp Group is Benzyl

3(S)-(benzyloxycarbonyl)methyl-1,4-dioxane-2,5-dione (i.e. monomer (VI) when the Gp group is benzyl) was prepared according to the example on pages 255 to 265 of Patent Application WO 2005/121904.

3(S)-(benzyloxycarbonyl)methyl-1,4-dioxane-2,5-dione is prepared in four stages from commercial L-glutamic acid according to this example of the patent WO 2005/121904. A first stage was a selective monoprotection stage carried out with benzyl alcohol in acid medium. During a second stage, the hydroxyacid was obtained by the diazotization of the protected amino acid in the presence of sodium nitrite in a water-dilute sulphuric acid mixture. The reaction of the latter with a bromoacetyl halide in the presence of triethylamine, during a third stage, produced the corresponding ester. The fourth and last cyclization stage was carried out under high dilution conditions by the slow addition of the bromoester to a basic solution maintained at a temperature of 60° C.

After this synthesis, the 3(S)-(benzyloxycarbonyl)methyl-1,4-dioxane-2,5-dione was recrystallized once from isopropyl alcohol and twice from toluene then dried under vacuum.

### Example I 2

### Synthesis of Monomer (III) when the Gp Group is Benzyl

3(S)-(1-benzyloxyethyl)-1,4-dioxane-2,5-dione (i.e. compound (III) when the Gp group is benzyl) was prepared in three stages from commercial O-benzyl-L-threonine (protected L-threonine). The hydroxy acid of the second stage was obtained by the diazotization of the protected L-threonine in the presence of sodium nitrite in a water-acetic acid mixture. The reaction of the hydroxy acid with a bromoacetyl halide in the presence of triethylamine produced the corresponding bromoester. The final cyclization stage was carried out under high dilution conditions by the slow addition of the bromoester to a basic solution maintained at a temperature of 60° C.

### Example I 3

### Synthesis of Monomer (IV) when the Gp Group is Benzyl

3(S)-(benzylmercapto) methyl-1,4-dioxane-2,5-dione (i.e. compound (IV) when the Gp group is benzyl) was prepared in 4 stages from commercial methyl (S)-glycidate. The hydroxy acid was obtained after hydrolysis of the methyl ester obtained by the action of a benzenethiol on methyl glycidate in the presence of triethylamine. The reaction of the hydroxy acid obtained with a bromoacetyl halide in the presence of triethylamine, and under an inert atmosphere, produced the corresponding bromoester. The final cyclization stage was carried out under high dilution conditions by the slow addition of the bromoester to a basic solution maintained at a temperature of 60° C.

### Example I 4

### Synthesis of Monomer (V) when the Gp Group is Benzyloxycarbonyl

Compound (V) (i.e. 3(S)-(4-benzyloxycarbonylamino)butyl-1,4-dioxane-2,5-dione when the Gp group is benzyloxycarbonyl) was prepared in 3 stages from commercial L-(N-benzyloxycarbonyl)lysine (protected lysine). The hydroxy acid is obtained by the diazotization of the protected lysine in the presence of sodium nitrite in a water-acetic acid mixture. The reaction of the hydroxy acid with a bromoacetyl halide in the presence of triethylamine produces the corresponding bromoester. The final cyclization stage is carried out under high dilution conditions by the slow addition of the bromoester to a basic solution maintained at a temperature of 60° C.

### II. Examples of the homopolymerization of 3-(2-benzyloxycarbonyl)ethyl 1,4-dioxane-2,5-dione (i.e. monomer (VI) having benzyl as the Gp group)

The homopolymerization reaction which was carried out in these examples was carried out according to the following reaction diagram, where n is the degree of polymerization, ROH is the protic initiator, here n-pentanol.

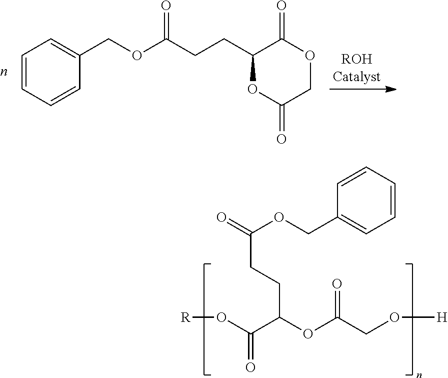

### Example II 1

### Polymerization Catalyzed with a Pyridine

3-(2-benzyloxycarbonyl)ethyl 1,4-dioxane-2,5-dione (1.0 mmol, 280 mg) was dissolved in 1 mL of DCM in a Schlenk tube previously dried under vacuum. The medium was preheated to +30° C. and, under stirring and a flow of argon, n-pentanol (0.04 mmol, 4.3 μL) and DMAP (0.04 mmol, 4.9 mg) were added to this medium. At the end of the reaction (total consumption of the monomer monitored by ¹H NMR), the reaction medium was then washed with 2N hydrochloric acid and water. The polymer was then precipitated by adding methanol then dried under vacuum.

The polymer obtained had the following characteristics:

Mn=6780; PDI=1.18

¹H NMR (CDCl₃, 300 MHz): δ ppm 7.34 (aromatic H); 5.24 (CHO); 5.11 (CH₂Ph); 4.80-4.54 (CH₂ Gly); 4.37 (CHOH); 4.19 (CH₂OH); 4.13 (CH₂CH₂CH₂O); 2.61-2.12 (CH₂CH₂CO₂Bz); 1.63 (CH₂CH₂CH₂O); 1.32 (CH₃CH₂CH₂CH₂CH₂O); 0.91 (CH₂CH₃).

### Example II 2

### Polymerization Catalyzed with a Combination of a Thiourea and a Tertiary Amine

3-(2-benzyloxycarbonyl)ethyl 1,4-dioxane-2,5-dione (0.72 mmol, 200 mg) was dissolved in 320 μL of DCM in a Schlenk tube previously dried under vacuum. The medium was preheated to 30° C. and, under stirring and a flow of argon, n-pentanol (0.029 mmol, 200 μL of a 0.145 M solution in DCM), thiourea 1 (0.029 mmol, 10.6 mg) and sparteine (0.029 mmol, 200 μL of a 0.145 M solution in DCM) were added to this medium. The reaction was completed in 15 minutes (total consumption of the monomer monitored by ¹H NMR). The reaction medium was then washed with 2N hydrochloric acid and water. The polymer was then precipitated by adding methanol then dried under vacuum.

The polymer obtained had the following characteristics:

Mn=6860, PDI=1.22

¹H NMR (CDCl₃, 300 MHz): δ ppm 7.34 (125H, aromatic); 5.22 (25H, CHO); 5.10 (50H, CH₂Ph); 4.86-4.52 (50H, CH₂ Gly); 4.37 (CHOH); 4.19 (CH₂OH); 4.11 (CH₂CH₂CH₂O); 2.54-2.37 (100H, CH₂CH₂CO₂Bz); 0.89 (CH₃CH₂CH₂CH₂CH₂O).

### Example II 3

### Polymerization Catalyzed with a Thiourea which Comprises a Tertiary Amine

3-(2-benzyloxycarbonyl)ethyl 1,4-dioxane-2,5-dione (1.0 mmol, 280 mg) was dissolved in 0.8 mL of DCM in a Schlenk tube previously dried under vacuum. The medium was preheated to 30° C. and, under stirring and a flow of argon, n-pentanol (0.02 mmol, 200 μL of a 0.1M solution of pentanol in DCM) and thiourea 2 (0.04 mmol, 16.0 mg) were added to this medium. The reaction was completed in 120 minutes (total consumption of the monomer monitored by ¹H NMR). The reaction medium was then washed with 2N hydrochloric acid and water. The polymer was then precipitated by adding methanol then dried under vacuum.

The polymer obtained had the following characteristics:

Mn=8750, PDI=1.22

¹H NMR (CDCl₃, 300 MHz): δ ppm 7.34 (250H, aromatic); 5.24 (50H, CHO); 5.11 (100H, CH₂Ph); 4.82-4.37 (100H, CH₂ Gly); 4.37 (CHOH); 4.18 (CH₂OH); 4.13 (CH₂CH₂CH₂O); 2.53-2.25 (200H, CH₂CH₂CO₂Bz); 1.63 (CH₂CH₂CH₂O); 1.32 (CH₃CH₂CH₂CH₂CH₂O); 0.91 (CH₃CH₂CH₂CH₂CH₂O).

### Example II 4

### Polymerization Catalyzed with a Combination of a Thiourea which Comprises a Tertiary Amine and a Tertiary Amine

3-(2-benzyloxycarbonyl)ethyl 1,4-dioxane-2,5-dione (0.5 mmol, 140 mg) was dissolved in 330 μL of DCM in a Schlenk tube previously dried under vacuum. The medium was preheated to +30° C. and, under stirring and a flow of argon, n-pentanol (0.025 mmol, 170 μL of a 0.145 M solution in DCM); thiourea 3 (0.025 mmol, 9.0 mg) and sparteine (0.025 mmol, 6.0 mg) were added to this medium. The reaction was completed in 30 minutes (total consumption of the monomer monitored by ¹H NMR). The reaction medium was then washed with 2N hydrochloric acid and with water. The polymer was then precipitated by adding methanol then dried under vacuum.

The polymer obtained had the following characteristics:

Mn=4910, PDI=1.18

¹H NMR (CDCl₃, 300 MHz): δ ppm 7.33 (100H, aromatic); 5.24 (20H, CHO); 5.11 (40H, CH₂Ph); 4.82-4.37 (100H, CH₂ Gly); 4.37 (CHOH); 4.18 (CH₂OH); 4.13 (CH₂CH₂CH₂O); 2.53-2.18 (80H, CH₂CH₂CO₂Bz); 1.63 (CH₂CH₂CH₂O); 1.30 (CH₃CH₂CH₂CH₂CH₂O); 0.90 (CH₃CH₂CH₂CH₂CH₂O).

### Example II 5

### Preparation of homopolymers with different degrees of polymerization by polymerization of 3-(2-benzyloxycarbonyl)ethyl 1,4-dioxane-2,5-dione, catalyzed by a pyridine

A 1M solution of 3-(2-benzyloxycarbonyl)ethyl 1,4-dioxane-2,5-dione (1.0 equiv) was prepared in DCM in a Schlenk tube previously dried under vacuum. The medium was preheated to 30° C. and, under stirring and a flow of argon, the initiator (1/X equiv) and DMAP (0.1 equiv) were added. At the end of the reaction (total consumption of the monomer monitored by ¹H NMR), the reaction medium was washed with 2N hydrochloric acid and water. The polymer was then precipitated by adding methanol, dried under vacuum and analyzed by SEC.

The following table shows all of the results obtained.

ROH = n-pentanol

| X = | ROH/ | | | |
|---|---|---|---|---|
| M/ROH | DMAP | Time (min) | Mn | PDI |
| 5 | 1 | 3 h | 19.10 | 1.24 |
| 10 | 1 | 7 h | 2870 | 1.27 |
| 25 | 3 | 16 h | 6780 | 1.18 |
| 50 | 5 | 17 h | 10800 | 1.18 |

### Example II 6

### Preparation of homopolymers with different degrees of polymerization by polymerization of 3-(2-benzyloxycarbonyl)ethyl 1,4-dioxane-2,5-dione catalyzed with a combination of a thiourea and a tertiary amine

A 1M solution of monomer (VI) (1.0 equiv) was prepared in DCM in a Schlenk tube previously dried under vacuum. The medium was preheated to 30° C. and, under stirring and a flow of argon, the initiator (1/X equiv), thiourea 1 (1/X or 2/X equiv) and sparteine (1/X 2/X equiv) were added. At the end of the reaction (total consumption of the monomer monitored by ¹H NMR), the reaction medium was washed with 2N hydrochloric acid and water. The polymer was then precipitated by adding methanol, dried under vacuum and analyzed by SEC.

The following table shows all of the results obtained.

ROH = n-pentanol

| X = | ROH/ | ROH/ | | | |
|---|---|---|---|---|---|
| M/ROH | thiourea | sparteine | Duration | Mn | PDI |
| 25 | 1 | 1 | 30 min | 6310 | 1.20 |
| 50 | 1 | 1 | 30 min | 8060 | 1.18 |
| 100 | 2 | 2 | 45 min | 1940 | 1.12 |

### III Example of the deprotection of a homopolymer derived from 3-(2-benzyloxycarbonyl)ethyl 1,4-dioxane-2,5-dione: obtaining a homopolymer for which Gp is hydrogen H

The deprotection reaction which was carried out in this example took place according to the following reaction diagram.

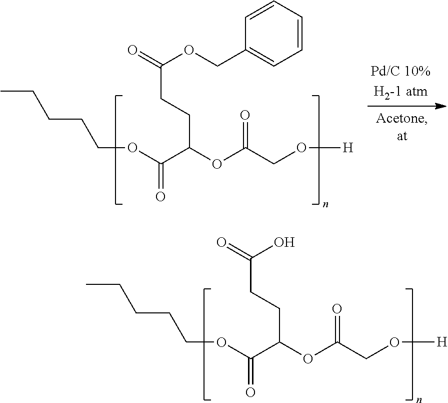

A homopolymer derived from monomer (VI) (150 mg, Mn=10800; PDI=1.18), originating from example II 5, was solubilized in acetone (10 mL). The catalyst (Pd/C 10%; 15 mg) was added under a flow of argon. The reaction medium was stirred at ambient temperature for 1 h under a hydrogen atmosphere (1 atm). The total deprotection was monitored by ¹H NMR. The reaction medium was filtered on celite. The solvent was eliminated under reduced pressure and the deprotected polymer was dried under vacuum in order to produce a white powder (90 mg, 90%).

The polymer obtained had the following characteristics:

Mn=8640; PDI=1.14

¹H NMR (acetone d6, 300 MHz): δ ppm 5.26 (50H, CHO); 4.94-4.72 (100H, CH₂ Gly); 4.30 (CHOH); 4.13 (CH₂OH); 4.00 (CH₂CH₂CH₂O); 2.49-2.12 (200H, CH₂CH₂CO₂Bz); 0.91 (CH₃CH₂CH₂CH₂CH₂O).

### IV Example of the copolymerization of glycolide and 3-(2-benzyloxycarbonyl)ethyl 1,4-dioxane-2,5-dione, catalyzed with a combination of a thiourea and a tertiary amine

The copolymerization reaction of which was carried out in this example took place according to the following reaction diagram, where n is the degree of polymerization, ROH is the protic initiator alcohol (here pentanol).

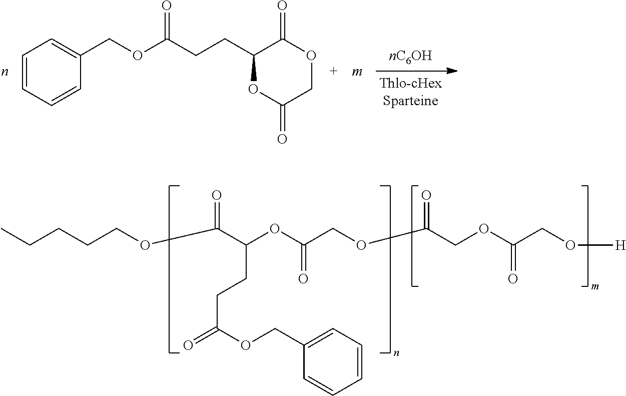

3-(2-benzyloxycarbonyl)ethyl 1,4-dioxane-2,5-dione (0.5 mmol, 140 mg) and glycolide (0.5 mmol, 60 mg) were dissolved in 0.5 mL of DCM in a Schlenk tube previously dried under vacuum. The medium was preheated to 30° C. and, under stirring and a flow of argon, n-pentanol (0.025 mmol, 2.7 μL) then thiourea 1 (0.025 mmol, 9.0 mg) and sparteine (0.025 mmol, 6.0 mg) in solution in 0.5 mL of DCM were added to this medium. The monomers were completely consumed after reaction for 10 minutes (monitored by ¹H NMR). The insolubles were filtered out.

The polymer obtained had the following characteristics:

Mn=7830, PDI=1.26

¹H NMR (CDCl₃, 300 MHz): δ ppm 7.34 (100H, aromatic); 5.25 (20H, CHO); 5.11 (40H, CH₂Ph); 4.90-4.50 (107H, CH₂ Gly (monomer (VI) and glycolide)); 2.51-2.12 (80H, CH₂CH₂CO₂Bz); 0.91 (CH₃CH₂CH₂CH₂CH₂O).

1. Polymerization method for 1,4-dioxane-2,5-diones in the presence of at least one generally protic initiator and at least one catalyst, said method being characterized in that the catalyst comprises at least one organic compound devoid of metal.

2. Polymerization method according to claim 1 in which said one catalyst is chosen from:
the pyridines, substituted or not;
the sulphonic acids of formula R′SO₃H, where R′ is an aryl or alkyl group;
the cyclic or acyclic guanidines;
the polycyclic tertiary amines;
the mono or poly-phosphazenes;
the combinations:
of at least one thiourea of general formula R₁NH—C(═S)—NHR₂ in which the R₁ and R₂ groups, distinct or not, are aryl or alkyl groups, optionally substituted, and
of at least one tertiary amine, aliphatic or aromatic, mono or polyamine,
with a thiourea/tertiary amine ratio preferably of 0.1 to 10;
the thioureas of general formula R₃NH—C(═S)—NHR₄ in which the R₃ and R₄ groups, distinct or not, are aryl or alkyl groups, optionally substituted, comprising at least one tertiary amine function;
the combinations:
of at least one thiourea of general formula R₅NH—C(═S)—NHR₆ in which the R₅ and R₆ groups, distinct or not, are aryl or alkyl groups, optionally substituted, comprising at least one tertiary amine function, and
of at least one tertiary amine, aliphatic or aromatic, mono or polyamine.

3. Method according to claim 1 in which said generally protic initiator is a protic reagent such as water, an alcohol, a thiol, a primary amine, and preferably said generally protic initiator is n-pentanol.

4. Method according to claim 1 in which said 1,4-dioxane-2,5-diones are chosen from the compounds of formulae (I) to (VI) in the form of a pure enantiomer or a mixture of enantiomers: 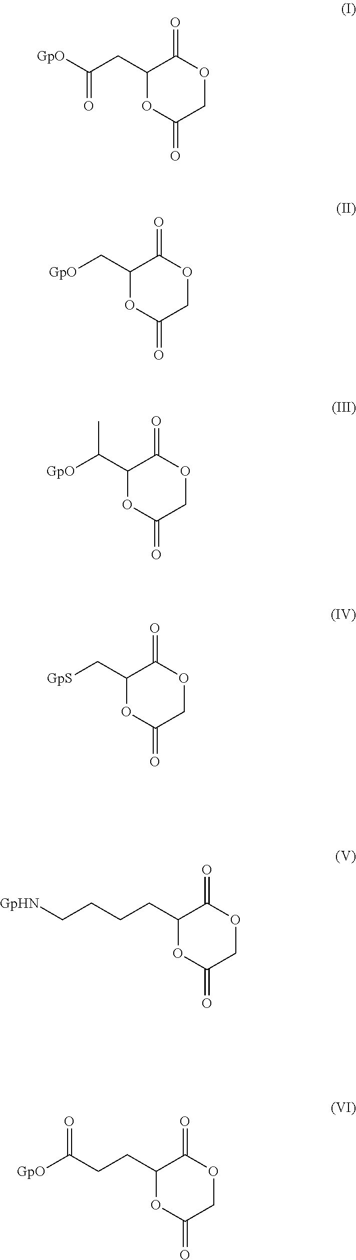
where the Gp group is a protective group or hydrogen H.

5. Polymerization method according to claim 4 such that the Gp group is benzyl for the compounds of formula (I), (II), (III), (IV) and (VI) and such that the Gp group is benzyloxycarbonyl for the compound of formula (V).

6. Method according to claim 1 characterized in that said 1,4-dioxane-2,5-dione is 3-(2-benzyloxycarbonyl)ethyl 1,4-dioxane-2,5-dione, preferably 3(S)-(2-benzyloxycarbonyl)ethyl 1,4-dioxane-2,5-dione, and the organic catalyst is a 4-aminopyridine, preferably DMAP.

7. Method according to claim 1 characterized in that said 1,4-dioxane-2,5-dione is 3-(2-benzyloxycarbonyl)ethyl 1,4-dioxane-2,5-dione, preferably 3(S)-(2-benzyloxycarbonyl)ethyl 1,4-dioxane-2,5-dione, and the organic catalyst is a thiourea comprising a tertiary amine, or a combination of at least one thiourea, optionally comprising a tertiary amine, and at least one tertiary amine.

8. Method according to claim 1, characterized in that a homopolymer is obtained.

9. Polymer obtained by the implementation of the method according to claim 8, characterized in that said polymer is a homopolymer.

10. Method according to claim 1, in which two monomers distinct from each other are copolymerized,
at least one of said monomers being chosen from the compounds of formulae (I) to (VI) in the form of a pure enantiomer or of a mixture of enantiomers, and
at least the other of said monomers being chosen from the compounds of formulae (I) to (VI) in the form of a pure enantiomer or of a mixture of enantiomers, and glycolide, optionally substituted.

11. Polymer obtained by the implementation of the method according to claim 10, characterized in that said polymer is a copolymer.

12. Polymer of a formula chosen from: 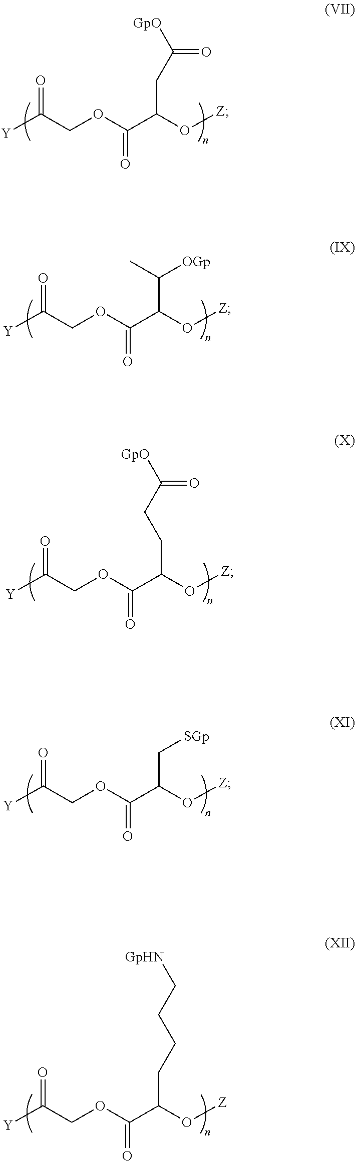
where the Gp group is a protective group or hydrogen H; where Y and Z, identical or different, are two terminal groups; and where n is the degree of polymerization,
said polymer being characterized in that it has a ratio of the weight average molecular weight (Mw) to the number average molecular weight (Mn) of less than 1.40, preferably less than 1.38, even more preferably less than 1.35.

13. Polymer comprising the repetition of two monomer units distinct from each other, at least one of said monomer units being chosen from the monomer units of formulae: 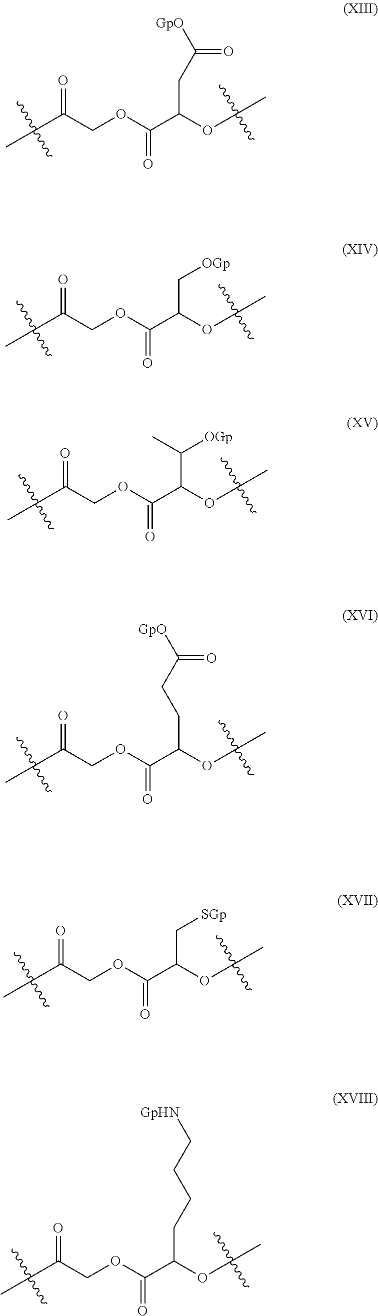
where the Gp group is a protective group, or hydrogen H;
and at least the other of said monomer units being chosen from the compounds of formulae (XIII), (XIV), (XV), (XVI), (XVII) and (XVIII), and glycolide, optionally substituted,
to the exclusion of a polymer comprising the repetition of the monomer unit (XIV) and of the lactide or 3,6-dimethyl-glycolide, said polymer being characterized in that it has a ratio of the weight average molecular weight (Mw) to the number average molecular weight (Mn) of less than 1.40, preferably less than 1.38, even more preferably less than 1.35.
